(19) United States
(12) Patent Application Publication
(10) Pub. No.: US 2025/0217450 A1
(43) Pub. Date: Jul. 3, 2025

(54) DETECTING RECURRING PATTERNS OF USER INTERFACE ACTIONS

(71) Applicant: ABBYY Development Inc., Dover, DE (US)

(72) Inventors: Ruslan Garashchuk, Moscow (RU); Andrew Myakutin, Moscow (RU); Denis Uzhegov, Perm (RU)

(21) Appl. No.: 18/398,742

(22) Filed: Dec. 28, 2023

(51) Int. Cl. G06F 18/2415; G06F 9/451; G06N 5/025

(52) U.S. Cl. CPC G06F 18/2415; G06F 9/451; G06N 5/025

(57) ABSTRACT

An example method of detecting recurring patterns of user interface actions comprises: receiving a sequence of user interface commands; identifying a plurality of split points of the sequence of user interface commands; generating a linear partition graph comprising a plurality of vertices corresponding to a subset of split points; identifying a subset of paths in the linear partition graph; and utilizing the subset of paths for identifying a recurring pattern in a new sequence of user interface commands.

### TECHNICAL FIELD

The implementations of the disclosure relate generally to computer systems and, more specifically, to systems and methods for detecting recurring patterns of user interface actions.

### BACKGROUND

User interaction with a software application (e.g., electronic mail, accounting system, online purchasing system, online travel booking system) may involve recurring performance of certain sequences of user interface actions (such as selecting or activating a user interface control, emitting keystrokes inputting one or more symbols, etc.).

### SUMMARY OF THE DISCLOSURE

In accordance with one or more aspects of the present disclosure, an example method of detecting recurring patterns of user interface actions comprises: receiving a sequence of user interface commands; identifying a plurality of split points of the sequence of user interface commands; generating a linear partition graph comprising a plurality of vertices corresponding to a subset of split points; identifying a subset of paths in the linear partition graph; and utilizing the subset of paths for identifying a recurring pattern in a new sequence of user interface commands.

In accordance with one or more aspects of the present disclosure, an example system for detecting recurring patterns of user interface actions comprises a memory and a processor coupled to the memory, the processor configured to: receive a sequence of user interface commands; identify a plurality of split points of the sequence of user interface commands; generate a linear partition graph comprising a plurality of vertices corresponding to a subset of split points; identify a subset of paths in the linear partition graph; and utilize the subset of paths for identifying a recurring pattern in a new sequence of user interface commands.

In accordance with one or more aspects of the present disclosure, an example computer-readable non-transitory storage medium comprises executable instructions that, when executed by a computer system, cause the computer system to: receive a sequence of user interface commands; identify a plurality of split points of the sequence of user interface commands; generate a linear partition graph comprising a plurality of vertices corresponding to a subset of split points; identify a subset of paths in the linear partition graph; and utilize the subset of paths for identifying a recurring pattern in a new sequence of user interface commands.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 schematically illustrates a high-level workflow for detecting recurring patterns of user interface actions, in accordance with aspects of the present disclosure;

FIG. 2 schematically illustrates an example of an encoded sequence of commands and a corresponding distribution of frequencies of occurrence of each unique element in the encoded sequence of commands, in accordance with aspects of the present disclosure;

FIGS. 3A-3B schematically illustrate an example of constructing the left and right sub-sequences and computing corresponding frequency distributions for all split points of an example sequence, in accordance with aspects of the present disclosure;

FIGS. 4A-4C schematically illustrate expanding the ranges of split points, in accordance with aspects of the present disclosure;

FIG. 5 schematically illustrates identifying a neighborhood of a specified local maximum of the quality metric values characterizing a sub-sequence of encoded sequence of user interface commands, in accordance with aspects of the present disclosure;

FIG. 6 schematically illustrates projecting split points onto a straight-line segment, in accordance with aspects of the present disclosure;

FIG. 7 schematically illustrates a set of segments corresponding to selected split points of an example sequence, in accordance with aspects of the present disclosure;

FIG. 8 schematically illustrates constructing an example set of edges of a linear partition graph, in accordance with aspects of the present disclosure;

FIG. 9 schematically illustrates constructing another example set of edges of a linear partition graph, in accordance with aspects of the present disclosure;

FIG. 10 schematically illustrates an example linear partition graph, in accordance with aspects of the present disclosure;

FIG. 11 schematically illustrates projection of an example sequence of commands onto a segment which is split into multiple bins, in accordance with aspects of the present disclosure;

FIG. 12 schematically illustrates projecting an example edge onto a segment, in accordance with aspects of the present disclosure;

FIG. 13 is a flow diagrams illustrating an example method of identifying repeating sequences of user interface commands for completing a certain task, in accordance with aspects of the present disclosure;

FIG. 14 is a flow diagrams illustrating an example method of identifying repeating sequences of user interface commands for completing a certain user interface form, in accordance with aspects of the present disclosure; and

FIG. 15 illustrates a block diagram of a computer system in accordance with some implementations of the present disclosure.

### DETAILED DESCRIPTION

Described herein are systems and methods for detecting recurring patterns of user interface actions, which allows automation of certain repeatedly performed tasks.

User interaction with a software application (e.g., an accounting system, online purchasing system, online travel booking system, etc.) may involve recurring performance of certain sequences of user interface actions, such as selecting or activating a user interface control, emitting keystrokes inputting one or more symbols, etc.

Sometimes, user interactions with a software application implementing a recurring task need to be modified. For example, when a user performs business travel bookings, the dates and destinations may change, while the rest of user interactions with the system (e.g., passenger name, address, seating preferences, payment methods) will remain essentially the same. Detecting recurring user interface actions with high degree of accuracy may enable their effective automation and/or logical reorganization of business processes containing such recurring tasks. The systems and methods of the present disclosure allow detecting, with a high degree of accuracy, recurring patterns of user interface actions.

The systems and methods of the present disclosure analyze recorded sequences of user interface actions and identify recurring patterns of user interface actions, which may correspond to recurring forms or tasks.

A sequence of commands may accomplish a certain task leading to a perceivable practical result (e.g., booking a trip, assigning an action item to a staff member, payment of an invoice, etc.). An instance of a task refers herein to a sequence of commands for completing a certain task based on a defined set of input parameters (e.g., booking a certain trip, assigning a specified action item to a certain staff member, payment of a specified invoice, etc.). Completing a task may involve navigating through and filling in one or more GUI forms, such that each form includes one or more GUI controls (e.g., input fields, radio-buttons, pull-down lists, menus, etc.). An instance of a form refers herein to a sequence of commands completing a certain form based on a defined set of input parameters.

Accordingly, the computer system implementing the methods described herein receives a recorded sequence of user interface actions. For identifying task instances, the computer system may extract, from the recorded sequence of user interface commands, one or more user interface commands that are related to a specified set of forms associated with a specified task. For identifying form instances, the computer system may extract, from the recorded sequence of user interface commands, one or more user interface commands that are related to a specified set of forms associated with a specified task. The computer system then encodes the sequence of user interface actions, thus producing an encoded sequence of commands.

Then, the computer system identifies candidate split points of the encoded sequence of commands and computes a corresponding quality metric value for each candidate split point. Based on the quality metric values, a subset of the plurality of split points corresponding to the local maxima of the quality metric is then selected.

The subset of split points forms the set of vertices of a linear partition graphs. Each path within the graph defines a corresponding partitioning of the encoded sequence into two or more sub-sequences. A subset of best paths is then selected.

For identifying task instances, the computer system generates a set of rules corresponding to the identified subset of paths, such that each rule reproduces a corresponding partitioning of the encoded sequence into two or more sub-sequences. The set of rules may be utilized for processing new (previously unseen) sequences of user interface commands in order to identify task instances.

For identifying form instances, the computer system may perform additional evaluation of the subset of paths to select the best path, which may be utilized for processing (previously unseen) sequences of user interface commands in order to identify form instances.

The identified instances of tasks and/or instances of forms may be utilized, e.g., for training a model which is then used for user interface automation. In an illustrative example, a user may be presented with a list of tasks which may be automatically performed by the identified user interface operations. Upon receiving the user's selection of a task, the task may be performed automatically using a corresponding recorded sequence of a user interface events, as described in more detail herein below.

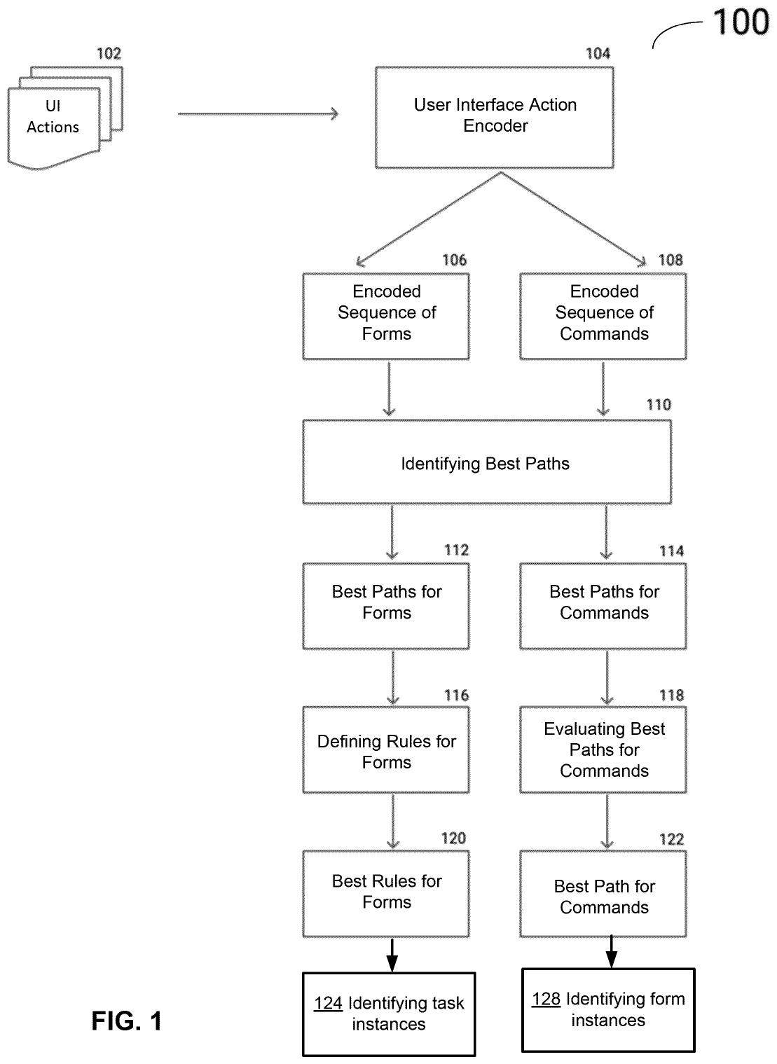

FIG. 1 schematically illustrates a high-level workflow for detecting recurring patterns of user interface actions, in accordance with aspects of the present disclosure. As schematically illustrated by FIG. 1, a computer system implementing the user interface action encoder 104 may receive a recorded sequence of user interface actions (“commands”) 102 (e.g., keyboard and mouse actions). In an illustrative example, the user interface actions and the user interface events caused by such actions may be intercepted and recorded, e.g., by a filtering driver.

Depending upon the specified goal (identifying instances of tasks or instances of forms), the user interface action encoder 104 may perform a corresponding sequence of operations to process the received sequence of commands 102.

For identifying task instances, the encoding of the user interface commands is performed at the form level, e.g., based on a user-defined set of forms. Accordingly, the user interface action encoder 104 may extract, from the input sequence of user interface commands, the user interface commands that are associated with the specified set of forms. Encoding of the set of forms is performed sequentially, by comparing the current form with those already encoded, such that a new form would thus receive a new encoding. Thus, an encoded sequence of forms 106 is produced.

For identifying form instances, the encoding of the incoming sequence of the user interface commands is performed at the level of GUI controls of the form. Accordingly, the user interface action encoder 104 may remove, from the input command sequence, all elements that are not related to the form that is being processed. Encoding of the resulting sequence of commands is performed sequentially, by comparing the current command with those already encoded, such that a new command would receive a new encoding. If the same command is found in the input sequence multiple times in a row, such occurrences may be combined into a single command (for example, AAA is converted to A). Thus, an encoded sequence of commands 108 is produced.

In some implementations, encoding a sequence of user interface commands may involve replacing each user interface command with a corresponding opcode (e.g., mouse move) and an optional set of parameters (e.g., mouse coordinates).

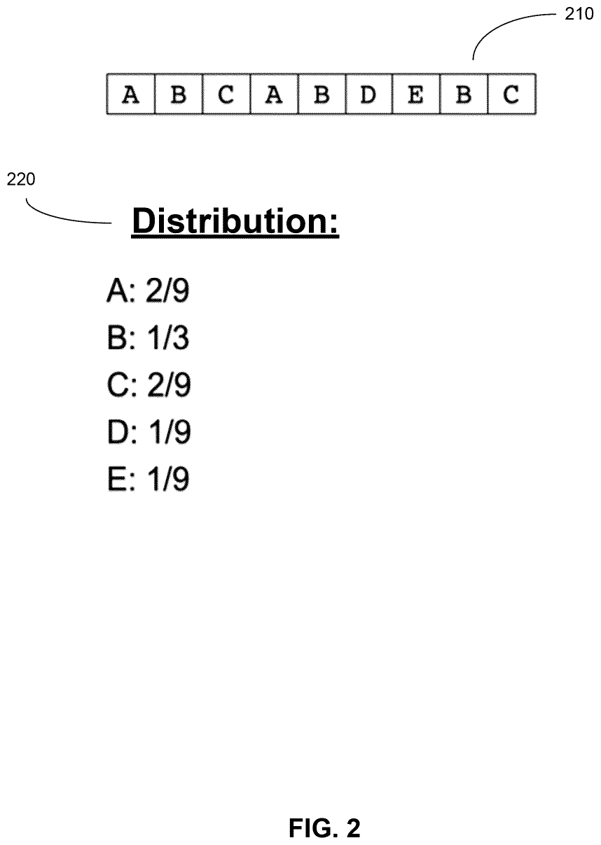

The operation 110 of identifying the best paths is then performed. For identifying either task instances or form instances, the operation 110 of identifying the best paths involves generating the overall distribution of unique elements of the input sequence of commands. FIG. 2 schematically illustrates an example of an encoded sequence 210 of commands and a corresponding distribution 220 of frequencies of occurrence of each unique element in the encoded sequence of commands.

The encoded sequence 210 may then be split into two or more sub-sequences, such that each sub-sequence has its frequency distribution that is similar to the frequency distribution of the encoded sequence 210. The sub-sequences are defined by respective split points within the encoded sequence 210, such that each split point defines the left and the right sub-sequences of the encoded sequence.

The similarity of each sub-sequences to the initial encoded sequence 210 may be measured by the dot product of the overall distribution corresponding to the initial sequence and the partial distribution corresponding to a chosen sub-sequence. Thus, for each split point, a corresponding value of the quality metric may be computed as the geometric mean of the similarities of the left and right sub-sequences to the initial sequence.

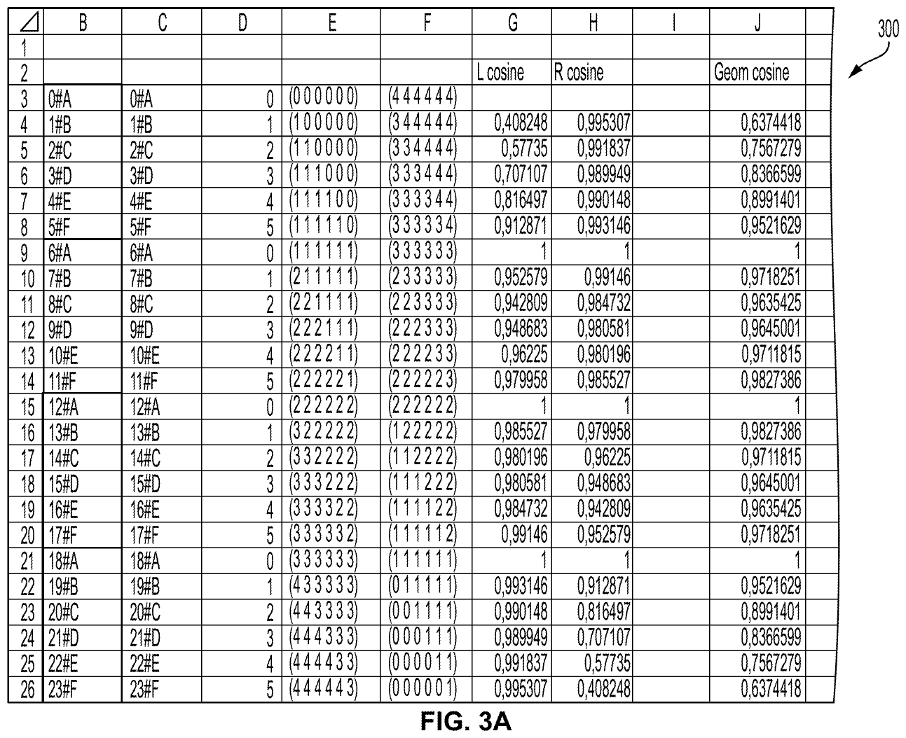

FIGS. 3A-3B schematically illustrate an example of constructing the left and right sub-sequences and computing corresponding frequency distributions for all split points of an example sequence ABCDEFABCDEFABCDEFABCDEF.

As illustrated by FIG. 3A, in each line of table 300:
each element of column C includes the serial number of the command within the sub-sequence, separated by “#” symbol from the identifier of the command of the sequence;
each element of column D contains the numeric identifier (position) of a corresponding split point;
each element of column E contains the frequency distribution corresponding to the left sub-sequence defined by the split point identified by a corresponding element of column D;
each element of column F contains the frequency distribution corresponding to the right sub-sequence defined by the split point identified by a corresponding element of column D;
each element of column G contains the value of the similarity metric of the left sub-sequence (defined by the split point identified by a corresponding element of column D) to the initial sequence;
each element of column H contains the value of the similarity metric of the right sub-sequence (defined by the split point identified by a corresponding element of column D) to the initial sequence;
each element of column J contains the geometric mean of the values of the left and right similarity values with respect to the frequency distribution of the initial sequence.

In FIG. 3B, plot 310 schematically illustrates the values of the similarity metric of the left sub-sequence (defined by the split point identified by a corresponding element of column D) to the initial sequence; plot 320 schematically illustrates the values of the similarity metric of the right sub-sequence (defined by defined by the split point identified by a corresponding element of column D) to the initial sequence; and plot 330 schematically illustrates the values of the geometric mean of the values of the left and right similarity values with respect to the frequency distribution of the initial sequence.

Local maxima of the values of the geometric mean of the values of the left and right similarity values with respect to the frequency distribution of the initial sequence (illustrated by the plot 330) may then be chosen as split points.

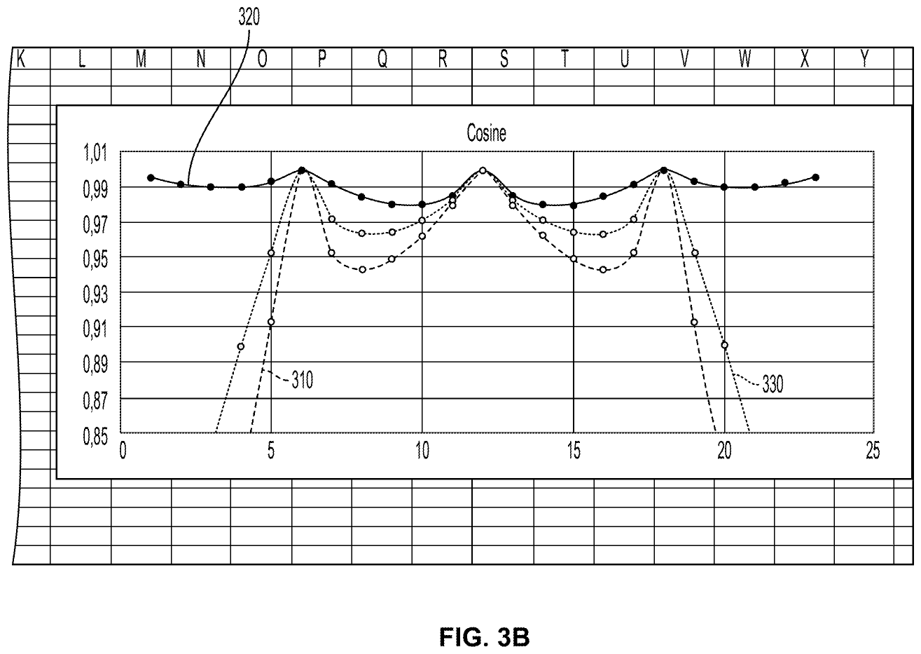

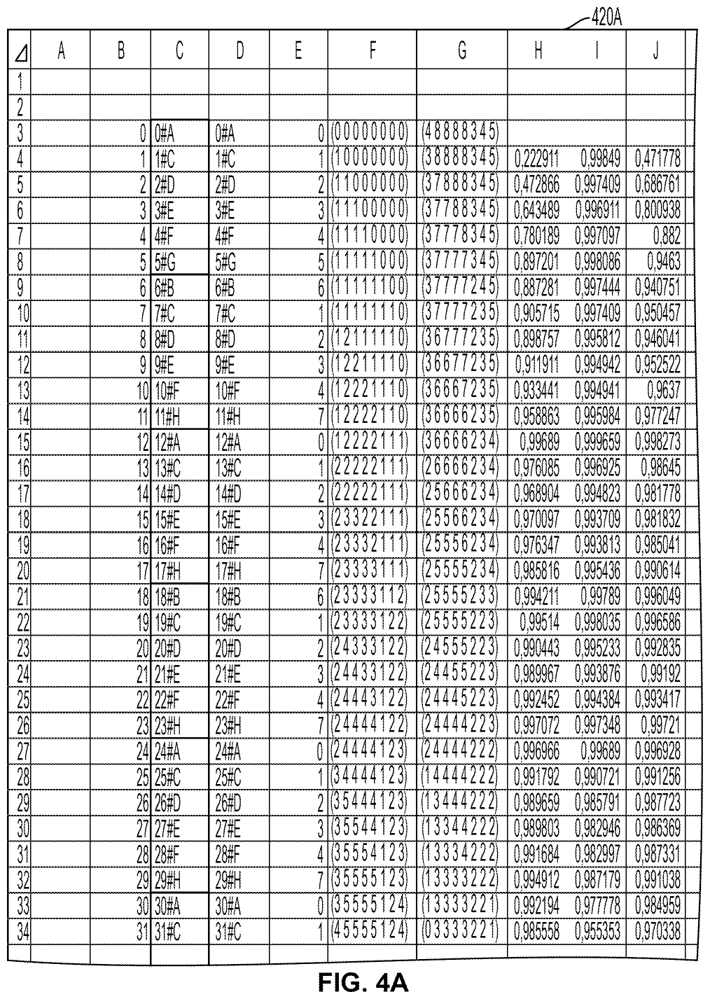

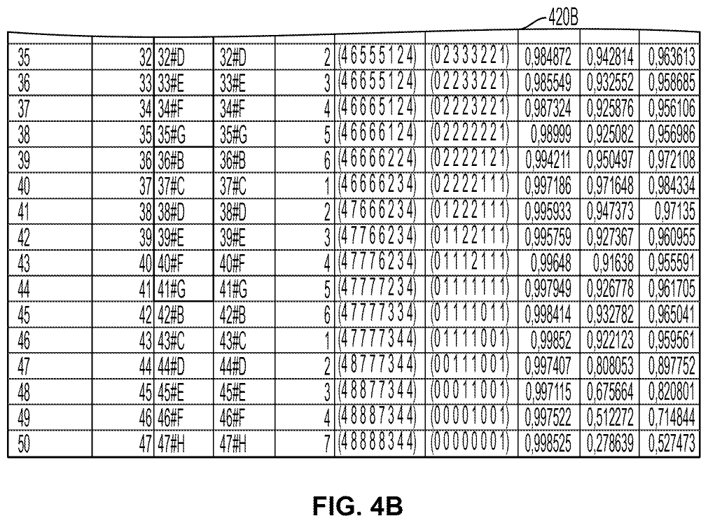

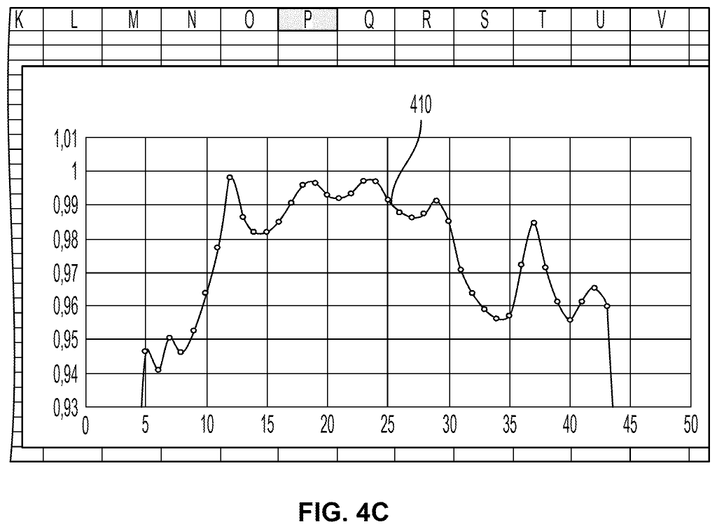

The ranges of split points may be expanded shifting the split points to the left and to the right, which might be needed due to weak peaks in a plot of the values of the geometric mean of the values of the left and right similarity values with respect to the frequency distribution of the initial sequence, as schematically illustrated by plot 410 of FIG. 4C. The meanings of the columns of table 420 of FIG. 4C are the same as the meanings of similarly named columns of table 300 of FIG. 3A.

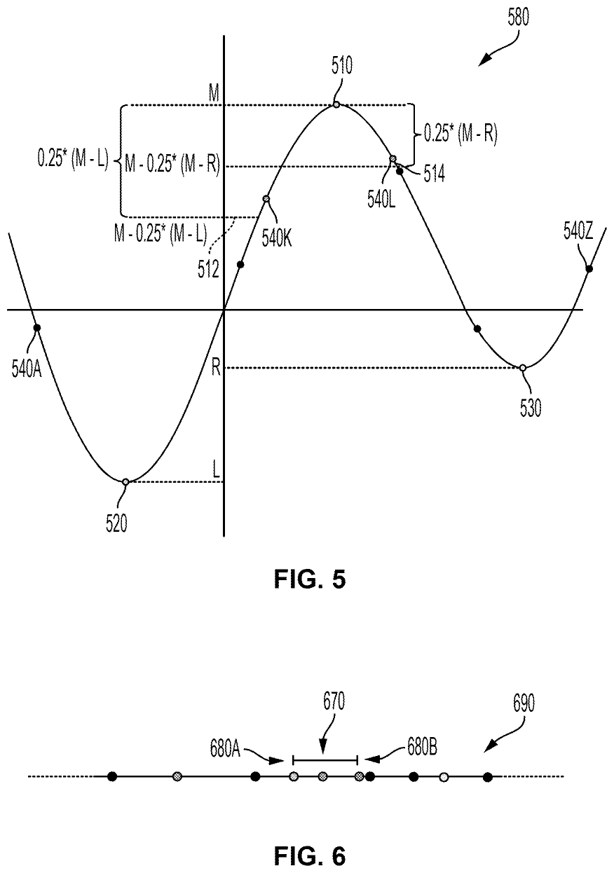

Then, as schematically illustrated by FIG. 5, for each split point identified by a corresponding local maximum M of the values of the geometric mean of the values of the left and right similarity values with respect to the frequency distribution of the initial sequence, its neighborhood may be defined as follows:
the point 512 on plot 580 having the vertical coordinate equal to M-0.25*(M-L) becomes the left boundary of the neighborhoodof the local maximum M; and
the point 514 on plot 330 having the vertical coordinate equal to M-0.25*(M-R) becomes the right boundary of the neighborhoodof the local maximum M;
where L and R are values of the left and right local minima, respectively, that are closest to the value of the local maximum M.

An example of identifying a neighborhood of a specified local maximum is schematically illustrated by FIG. 5. Point 510 having the vertical coordinate of M is the local maximum. Point 520 having the vertical coordinate of L is the left, with respect to point 510, local minimum closest to the point 510. Point 530 having the vertical coordinate of R is the right, with respect to point 510, local minimum closest to the point 510. Points 540A-540Z form a subset of all possible split points of the initial encoded sequence that have been identified as explained herein above with references to FIGS. 3A-3B.

The resulting neighborhood would include at least one split point (i.e., point 510 corresponding to the local maximum M itself). In some instances, additional split points (chosen from the subset of possible split points 540A-540Z) may fall within the neighborhood of the point 510 corresponding to the local maximum M. Thus, as schematically illustrated by FIG. 5, the neighborhood includes, in addition to the split point (i.e., point 510 corresponding to the local maximum M), the points 540K and 540L that have earlier been identified as possible split points and have their horizontal coordinates between the horizontal coordinates of points 512 and 514 which define the neighborhood of the local maximum point 510.

Then, as schematically illustrated by FIG. 6, the split points 510, 520, 530, and 540A-540N may be projected onto a horizontal line 690. The segment 670 is formed by the projections 680A and 680B of the leftmost and rightmost split points 540K and 540L of the neighborhood of the chosen local maximum 510.

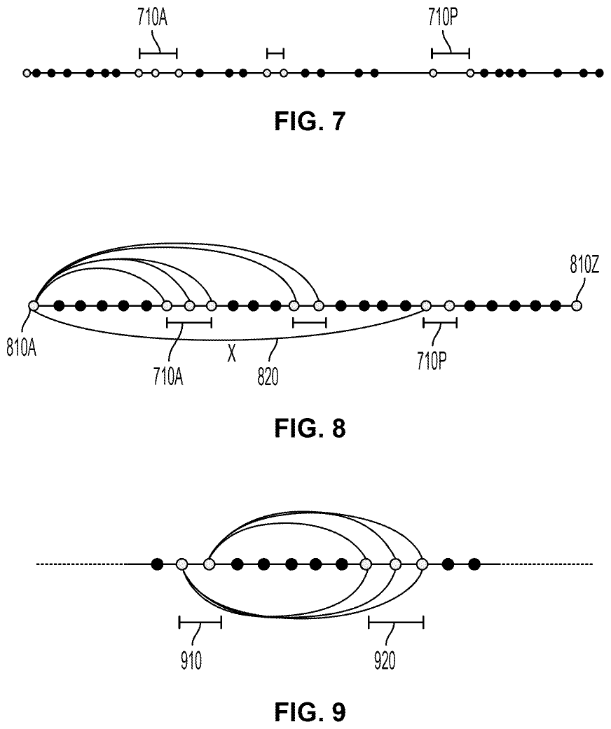

Similar operations are performed with respect to other local maxima of the values of the geometric mean of the values of the left and right similarity values with respect to the frequency distribution of the initial sequence (illustrated by the plot 330), thus resulting in the set of segments 710A-710P, as schematically illustrated by FIG. 7.

Then, as schematically illustrated by FIG. 8, a set of arcs (referred to herein as “edges,” which is the term that is generally accepted in the graph theory for non-directional arcs) is constructed between the starting and final points 810A, 810Z of the sequence and the split points found within the segments 710A-710P. In some implementations, the process of constructing the edges may be governed by the following set of rules:
(a) an edge may not traverse more than one segment 710A-710P;
(b) any edge 820 that violates the rule (a) is penalized, and the value X of the penalty depends upon the absolute value of the local maxima corresponding to each of the segments; and
(c) the total number of segments traversable by an edge even with a penalty is limited by a predefined threshold number.

Thus, as schematically illustrated by FIG. 9, the total number of edges between two segments 910, 920 having m and n split points, respectively, would be equal m*n. In the illustrative example, m=3, n=2, and the total number of edges is 6.

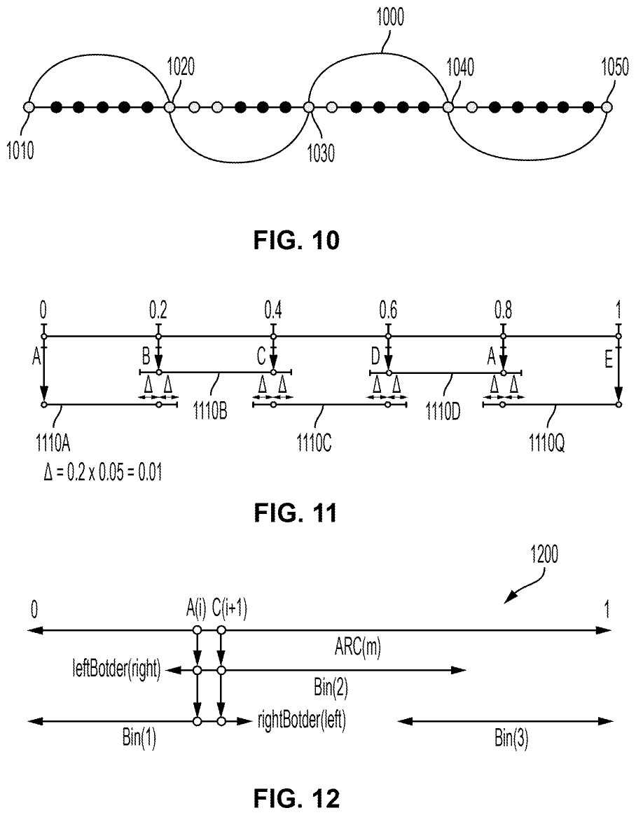

As schematically illustrated by FIG. 10, the resulting set of edges together with their endpoints forms a linear partition graph. Each path within the graph defines a corresponding partitioning the initial sequence into a set of sub-sequences, such that each element of the initial sequence is found in the set of sub-sequences exactly once. In FIG. 10, an example path 1000 in the graph of linear partitioning is shown as traversing the split points 1010, 1020, 1030, 1040, and 1050.

The linear partition graph may be utilized for identifying the minimum repeating pattern within the initial sequence, which is performed by iterating over possible paths in the reverse order of their respective quality metric values. The quality of a path may be measured by the sum of the quality metric values of the edges forming the path. The quality of an edge may be measured by the similarity between the overall distribution of the initial sequence and the distributions of sub-sequences defined by the split points lying between and including the endpoints of the edge. The quality of an edge may be reduced by a penalty for skipping local maxima and/or for failure to meet certain other quality requirements. Thus, the quality of an edge does not depend upon the quality of a path to which it may belong.

Thus, at least a predefined number of possible paths in the graph may be iterated in the reverse order of their respective quality metric values. In various illustrative examples, the predefined number of possible paths for identifying task instances may be 10 and for identifying form instances may be 218. In some implementations, a pretrained neural network may be employed for iterating the possible paths within the graph.

Referring again to FIG. 1, the identified set of best paths (set of best paths 112 for identifying form instances or set of best paths 114 for identifying task instances) constitutes the result of operation 110.

For identifying form instances, the set of best paths 112 is fed to the operation 116. At operation 116, the computer system implementing workflow 100 defines and applies path selection rules to the set of best paths 112. For each path of the set of paths 112, one or more rules are constructed.

A simple rule may be constructed based upon the frequencies of form occurrence: initially, a form is selected that is close to one of the endpoints of the sub-sequence corresponding to the path, and then one or more forms are selected that have their respective frequencies of occurrence above a predefined threshold frequency. An example of such a rule is (S) (A or B or C) (E), which means that a task instance starts with the element S, followed by element A or B or C, and followed by element E.

More complex rules may be expressed by graphs and/or regular expressions. A rule-encoding graph may include the vertices and edges that are present in a specified partition of the initial sequence. A subset of vertices of the graph are designated as initial vertices, and another subset of vertices are designated as final vertices. A graph-based rule is successfully applied to a sequence if the sequence matches a path in a graph from one of the initial vertices to one of the final vertices. An example of such a rule is (S1 or S2) ([AB] or C) (E), which means that a task instance starts with element S1 or S2, followed by AB or C, and followed by element E.

The generated rules may be ranked by the potential number of possible combination of elements which may be matched by each rule. Simple rules are preferred over complex rules since they usually cover larger numbers of possible combinations of elements.

For each identified path, the best matching rule may be chosen. The quality of matching a rule to a path may be measured by the difference between the partition created by the path and the closest partition created by the rule. Among all pairs of paths and rules, a predefined number of best matching pairs is chosen, thus producing the best rules 120.

At operation 124, the rules 120 are utilized for processing new (previously unseen) sequences of user interface commands in order to identify task instances by detecting command patterns that are specified by the rules 120.

Referring gain to FIG. 1, as noted herein above, operation 110 produces a set of best paths (a set of best paths 112 for identifying form instances or a set of best paths 114 for identifying task instances).

For identifying task instances, the set of best paths 114 is fed to the operation 118. At operation 118, the computer system implementing workflow 100 performs the additional evaluation of the identified paths and corresponding partitions of sequences of commands. The quality of a path may be measured by the initial quality of the path and the variance of the distribution of positions of each command within the path.

A path may be represented by a sequence of non-intersecting edges of the linear partition graph. Each edge of a path represents an element of a partition of the initial sequence of commands, such that all edges of the path cover all elements of the initial sequence. The number of commands traversed by different edges may differ.

For estimating the variance of the distribution of command positions inside the edges, which would be independent of the number of commands traversed by any given edge, each edge may be projected onto a segment [0,1].

The segment [0,1] may be covered by a set of N bins, in which the number of bins does not depend upon the number of commands traversed by a single edge. In an illustrative example, the segment [0,1] may be split into a set of N sub-segments, each having the length of 1/N. The right ends of all sub-segments, except for the last one, may be shifted to the right, e.g., by the value of 0.05*L. The left ends of all sub-segments, except for the first one, may be shifted to the left, e.g., by the value of 0.05*L. Thus, the length of the first and last sub-segment would be 1.05*L, while the length of the inner sub-segments would be 1.1*L, and each sub-segment would intersect with a neighboring one by 0.05*L.

FIG. 11 schematically illustrates an example of projection of the sequence of commands ABCDAE onto segment [0,1] which is split into five bins defined by corresponding sub-segments 1110A-1110Q. Each of the command falls into one or two bins. If a command falls into one bin, the number of the bin weighted by weight=1 is associated with the resulting distribution. If a command falls into two bins, their numbers weighted by weight₁+weight₂=1 are associated with the resulting distribution. The individual weights for each of the two bins are calculated is follows:

$$X = \frac{i}{N ( commands ) - 1}$$

$${weight}_{left} = \frac{{rightBorder}_{left} - X}{{rightBorder}_{left} - {leftBorder}_{right}}$$

$${weight}_{right} = \frac{X - {leftBorder}_{right}}{{rightBorder}_{left} - {leftBorder}_{right}}$$

where X is the projection of the command into segment [0,1] and
i is the index of the command in the edge of the path,
N (commands) is the number of commands in the sequence,
rightBorder_{left} is the value of the right border of the sub-segment defining the left bin of the two bins associated with the command,
leftBorder_{left} is the value of the left border of the sub-segment defining the left bin of the two bins associated with the command,
rightBorder_{right} is the value of the right border of the sub-segment defining the right bin of the two bins associated with the command, and
leftBorder_{right} is the value of the left border of the sub-segment defining the right bin of the two bins associated with the command.

While an edge may traverse a large number of commands, the number of bins may be smaller, in which case several commands may each become associated with a pair of neighboring bins. For such commands, the weights associated with each of the two neighboring bins would be different from each other.

FIG. 12 schematically illustrates an example 1200 of projecting an edge onto the segment [0,1]. The number of bins is three. Two neighboring elements, corresponding to the commands A(i) and C(i+1), are associated with Bin(1) and Bin(2), respectively.

According to the above equations, the weight associated with the command A(i) for Bin(1) would exceed the weight associated with the command C(i+1) for the same bin; conversely, the weight associated with the command A(i) for Bin(2) would be less than the weight associated with the command C(i+1) for the same bin.

Referring again to FIG. 11, which schematically illustrates an example of projection of the sequence of commands ABCDAE onto segment [0,1] which is split into five bins, an example distribution of the commands to bins (numbered from left to right) is as follows:
command A: Bin(1) with the weight of 1.0, Bin(4) with the weight of 0.5, and Bin(5) with the weight of 0.5;
command B: Bin(1) with the weight of 0.5, Bin(2) with the weight of 0.5;
command C: Bin(2) with the weight of 0.5, Bin(3) with the weight of 0.5;
command D: Bin(3) with the weight of 0.5, Bin(4) with the weight of 0.5; and
command E: Bin(5) with the weight of 1.0.

The variance of the distribution of command positions may be computed as follows:

$$Var ( X ) = E ( {X}^{2} ) - {( E ( X ) )}^{2}$$

where Var(X) is the variance of the distribution of positions of command (X),
E(x) is the expected value of the distributions, and
E(x²) is the expected value of the squared distributions.

The expected value E(x) may be computed as follows:

$$E [ X ] = \frac{{\sum }_{i = 1}^{N} {x}_{i} {p}_{i}}{{\sum }_{i = 1}^{N} {p}_{i}} = \frac{{x}_{1} {p}_{1} + {x}_{2} {p}_{2} + … + {x}_{n} {p}_{n}}{{p}_{1} + {p}_{2} + … + {p}_{n}}$$

where i is the bin number,
xᵢ is the i-th bin,
N is the number of bins, and
pᵢ is the weight associated with the i-th bin.

Thus, the example expected values of the distributions may be computed as follows:

$$E ( A ) = \frac{1 * 1. + 2 * 0. + 3 * 0. + 4 * 0.5 + 5 * 0.5}{1 + 0. + 0. + 0.5 + 0.5} = 2.75$$

$$E ( B ) = \frac{1 * 0.5 + 2 * 0.5 + 3 * 0. + 4 * 0. + 5 * 0.}{0.5 + 0.5 + 0. + 0. + 0.} = 1.5$$

$$E ( C ) = \frac{1 * 0. + 2 * 0.5 + 3 * 0.5 + 4 * 0. + 5 * 0.}{0 + 0.5 + 0.5 + 0. + 0.} = 2.5$$

$$E ( D ) = \frac{1 * 0. + 2 * 0. + 3 * 0.5 + 4 * 0.5 + 5 * 0.}{0. + 0. + 0.5 + 0.5 + 0.} = 3.5$$

$$E ( E ) = \frac{1 * 0. + 2 * 0. + 3 * 0. + 4 * 0. + 5 * 1.}{0. + 0. + 0. + 0. + 1.} = 5.$$

The example expected values of the squared distributions may be computed as follows:

$$E ( {A}^{2} ) = \frac{{1}^{2} * 1. + {2}^{2} * 0. + {3}^{2} * 0. + {4}^{2} * 0.5 + {5}^{2} * 0.5}{1 + 0. + 0. + 0.5 + 0.5} = 10.75$$

$$E ( {B}^{2} ) = \frac{{1}^{2} * 0.5 + {2}^{2} * 0.5 + {3}^{2} * 0. + {4}^{2} * 0. + {5}^{2} * 0.}{0.5 + 0.5 + 0. + 0. + 0.} = 2.5$$

$$E ( {C}^{2} ) = \frac{{1}^{2} * 0. + {2}^{2} * 0.5 + {3}^{2} * 0.5 + {4}^{2} * 0. + {5}^{2} * 0.}{0 + 0.5 + 0.5 + 0. + 0.} = 6.5$$

$$E ( {D}^{2} ) = \frac{{1}^{2} * 0. + {2}^{2} * 0. + {3}^{2} * 0.5 + {4}^{2} * 0.5 + {5}^{2} * 0.}{0. + 0. + 0.5 + 0.5 + 0.} = 12.5$$

$$E ( {E}^{2} ) = \frac{{1}^{2} * 0. + {2}^{2} * 0. + {3}^{2} * 0. + {4}^{2} * 0. + {5}^{2} * 1.}{0. + 0. + 0. + 0. + 1.} = 25.$$

Finally, the example variances of distributions of positions of commands for the edge corresponding to the sub-sequence of commands ABCDAE may be computed as follows:

$$Var ( A ) = 10.75 - {2.75}^{2} = 3.1875$$

$$Var ( B ) = 2.5 - {1.5}^{2} = 0.25$$

$$Var ( C ) = 6.5 - {2.5}^{2} = 0.25$$

$$Var ( D ) = 12.5 - {3.5}^{2} = 0.25$$

$$Var ( E ) = 25. - {5.}^{2} = 0.$$

The value of the variance of the edge corresponding to the sub-sequence of commands ABCDAE may be computed as the sum of the variances of the command distributions:

$$Var ( ABCDAE ) = Var ( A ) + Var ( B ) + Var ( C ) + Var ( D ) + Var ( E ) = 3.1875 + 0.25 + 0.25 + 0.25 + 0. = 3.9375$$

The value of the variance of a path may be computed as the sum of the variances of its edges.

Thus, the variance of the command position distributions depends on the number of bins and the similarity of the edges to each other. The more bins there are and the less the edges are similar to each other, the more heterogeneous the distribution of the commands in sub-sequence of commands corresponding to the edge will be, and, accordingly, the greater the variance value will be. In other words, the smaller the path variance value, the better the result. In the ideal case, when the position of each command in each bin is the same for all edges of the path, the variance would be zero.

Referring again to FIG. 1, as noted herein above, at operation 118, the computer system implementing workflow 100 performs the additional evaluation of the identified paths and corresponding partitions of sequences of commands. Since the higher the value of the initial quality of the path, the higher the position it occupies, and, conversely, the lower the dispersion of the path, the better the result, the difference between the initial quality of the path and its dispersion is taken as the final value of the path quality. Thus, the path having the highest posterior score chosen as the best path 122.

At operation 128, the best path 122 is utilized for partitioning new (previously unseen) encoded sequences of user interface commands in order to identify form instances. Each edge of the best path 122 would identify a corresponding instance of a form.

The identified recurring patterns (e.g., corresponding to task instances or commands instances) may be utilized, e.g., for training a model which is then used for user interface automation. In an illustrative example, a user may be presented with a list of tasks which may be automatically performed by the identified user interface operations. Upon receiving the user's selection of a task, the task may be performed automatically using a corresponding recorded sequence of a user interface events.

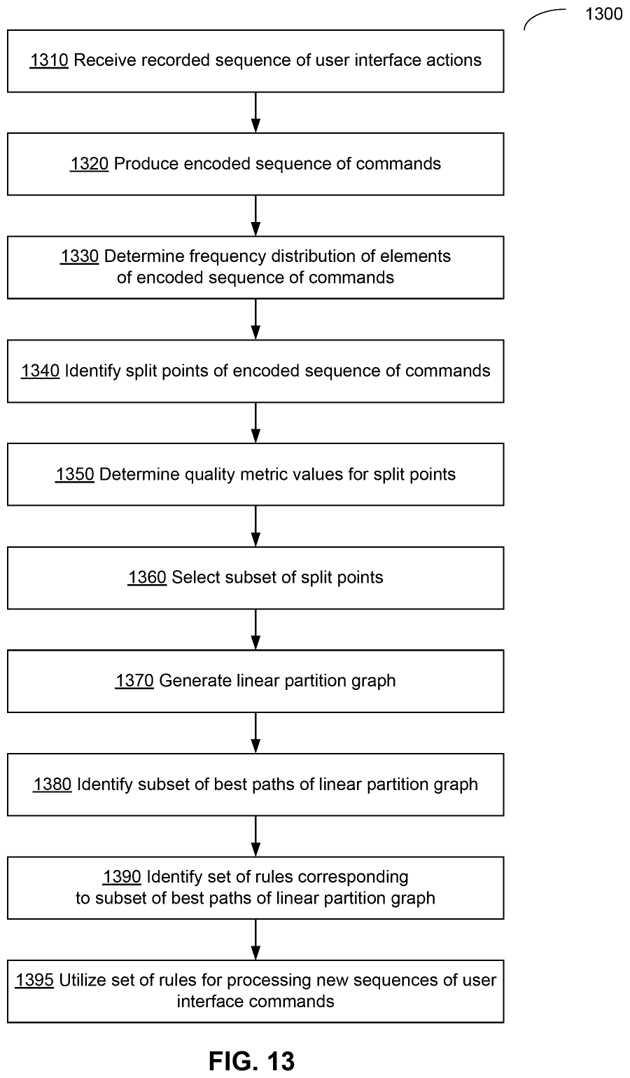

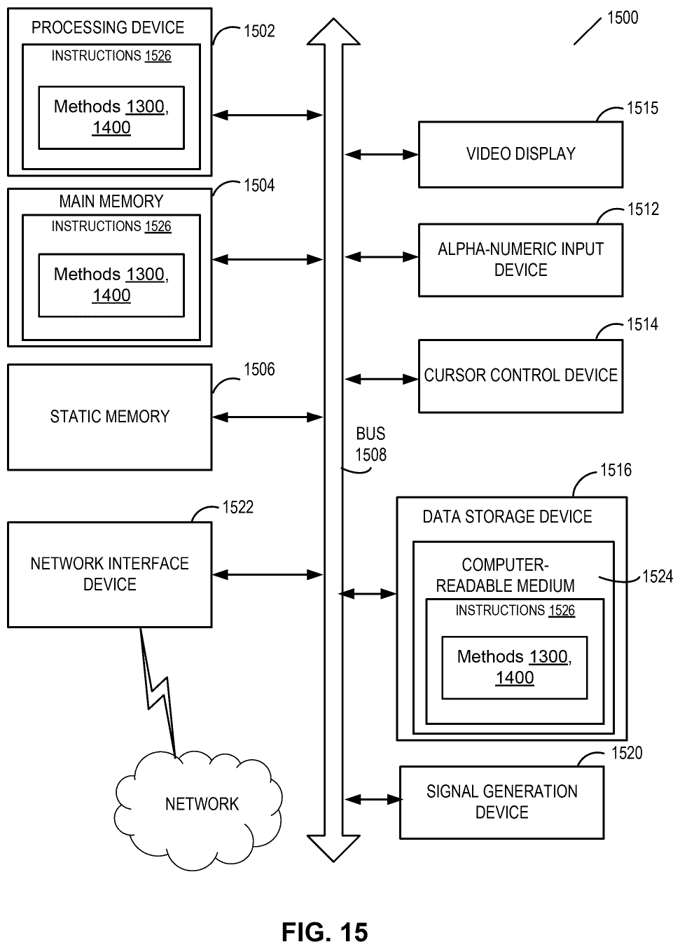

FIG. 13 is a flow diagrams illustrating an example method 1300 of identifying repeating sequences of user interface commands for completing a certain task, in accordance with aspects of the present disclosure. Method 1300 may be performed by processing logic that may comprise hardware (e.g., circuitry, dedicated logic, programmable logic, microcode, etc.), software (such as instructions run on a processing device), firmware, or a combination thereof. In one implementation, method 1300 may be performed by a computer system (e.g., computer system 1500 of FIG. 15). In certain implementations, method 1300 may be performed by a single processing thread. Alternatively, method 1300 may be performed by two or more processing threads, each thread executing one or more individual functions, routines, subroutines, or operations of the method. In an illustrative example, the processing threads implementing method 1300 may be synchronized (e.g., using semaphores, critical sections, and/or other thread synchronization mechanisms). Alternatively, the processing threads implementing method 1300 may be executed asynchronously with respect to each other. Therefore, while FIG. 13 and the associated description list the operations of method 1300 in certain order, various implementations of the methods may perform at least some of the described operations in parallel and/or in arbitrary selected orders. In some implementations, certain operations of method 1300 may be omitted.

At block 1310, the computer system implementing the method receives a recorded sequence of user interface actions. In some implementations, the computer system may extract, from the recorded sequence of user interface commands, one or more user interface commands that are related to a specified set of forms associated with a specified task, as described in more detail herein above.

At block 1320, the computer system encodes the sequence of user interface actions, thus producing an encoded sequence of commands for completing a certain task. In some implementations, the encoded sequence of commands may correspond to a sequence of forms comprised by the task, as described in more detail herein above.

At block 1330, the computer system determines a frequency distribution of unique elements of the encoded sequence of commands, as described in more detail herein above.

At block 1340, the computer system identifies a plurality of split points of the encoded sequence of commands, as described in more detail herein above.

At block 1350, the computer system determines, for each split point of the plurality of split points, a corresponding quality metric value, as described in more detail herein above.

At block 1360, the computer system selects, based on the quality metric values, a subset of the plurality of split points corresponding to the local maxima of the quality metric, as described in more detail herein above.

At block 1370, the computer system generates a linear partition graph, the vertices of which correspond to the subset of split points, and the edges selectively connect certain vertices. Each path within the graph defines a corresponding partitioning of the encoded sequence into two or more sub-sequences.

At block 1380, the computer system identifies a subset of best paths within the linear partition graph. The quality of a path may be measured by the sum of the quality metric values of the edges forming the path. The quality of an edge may be measured by the similarity between the overall distribution of the initial sequence and the distributions of sub-sequences defined by the split points lying between and including the endpoints of the edge. The quality of an edge may be reduced by a penalty for skipping local maxima and/or for failure to meet certain other quality requirements, as described in more detail herein above.

At block 1390, the computer system identifies a set of rules corresponding to the identified subset of paths, such that each rule reproduces a corresponding partitioning of the encoded sequence into two or more sub-sequences, as described in more detail herein above.

At block 1395, the computer system utilizes the set of rules for processing new (previously unseen) sequences of user interface commands in order to identify recurring patterns of user interface commands corresponding to task instances. The identified task instances may be utilized, e.g., for training a model which is then used for user interface automation.

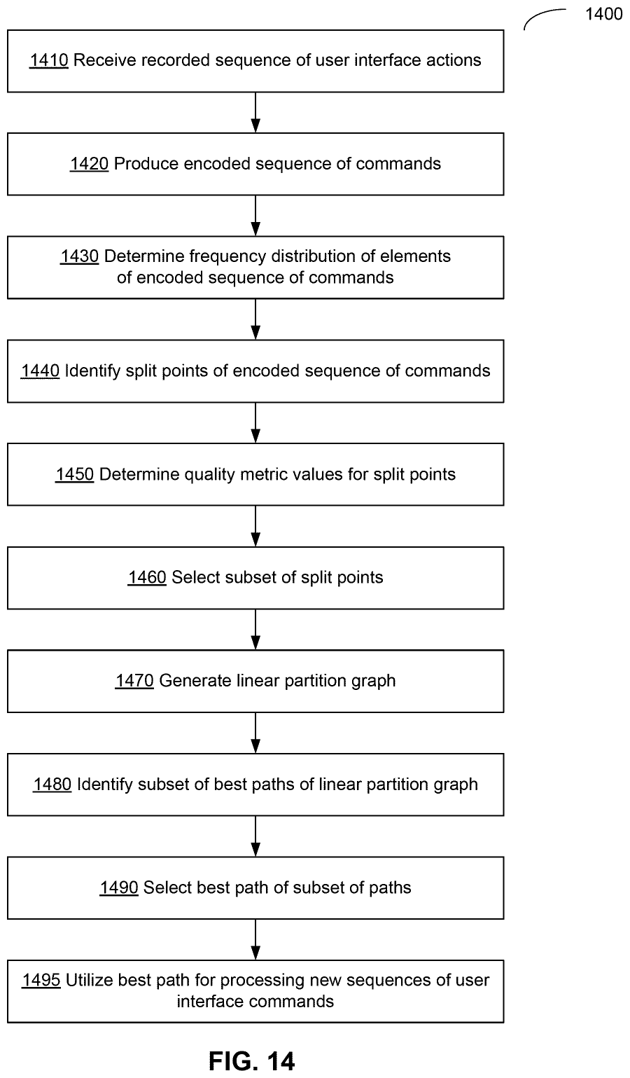

FIG. 14 is a flow diagrams illustrating an example method 1400 of identifying repeating sequences of user interface commands for completing a certain user interface form, in accordance with aspects of the present disclosure. Method 1400 may be performed by processing logic that may comprise hardware (e.g., circuitry, dedicated logic, programmable logic, microcode, etc.), software (such as instructions run on a processing device), firmware, or a combination thereof. In one implementation, method 1400 may be performed by a computer system (e.g., computer system 1500 of FIG. 15). In certain implementations, method 1400 may be performed by a single processing thread. Alternatively, method 1400 may be performed by two or more processing threads, each thread executing one or more individual functions, routines, subroutines, or operations of the method. In an illustrative example, the processing threads implementing method 1400 may be synchronized (e.g., using semaphores, critical sections, and/or other thread synchronization mechanisms). Alternatively, the processing threads implementing method 1400 may be executed asynchronously with respect to each other. Therefore, while FIG. 14 and the associated description list the operations of method 1400 in certain order, various implementations of the methods may perform at least some of the described operations in parallel and/or in arbitrary selected orders. In some implementations, certain operations of method 1400 may be omitted.

At block 1410, the computer system implementing the method receives a recorded sequence of user interface actions. In some implementations, the computer system may extract, from the recorded sequence of user interface commands, one or more user interface commands that are related to a specified form, as described in more detail herein above.

At block 1420, the computer system encodes the sequence of user interface actions, thus producing an encoded sequence of commands for completing a certain user interface form, as described in more detail herein above.

At block 1430, the computer system determines a frequency distribution of unique elements of the encoded sequence of commands, as described in more detail herein above.

At block 1440, the computer system identifies a plurality of split points of the encoded sequence of commands, as described in more detail herein above.

At block 1450, the computer system determines, for each split point of the plurality of split points, a corresponding quality metric value, as described in more detail herein above.

At block 1460, the computer system selects, based on the quality metric values, a subset of the plurality of split points corresponding to the local maxima of the quality metric, as described in more detail herein above.

At block 1470, the computer system generates a linear partition graph, the vertices of which correspond to the subset of split points, and the edges selectively connect certain vertices. Each path within the graph defines a corresponding partitioning of the encoded sequence into two or more sub-sequences.

At block 1480, the computer system identifies a subset of best paths within the linear partition graph. The quality of a path may be measured by the sum of the quality metric values of the edges forming the path. The quality of an edge may be measured by the similarity between the overall distribution of the initial sequence and the distributions of sub-sequences defined by the split points lying between and including the endpoints of the edge. The quality of an edge may be reduced by a penalty for skipping local maxima and/or for failure to meet certain other quality requirements, as described in more detail herein above.

At block 1490, the computer system selects the best path from the identified subset of paths, based on additional evaluation of the subset of paths, as described in more detail herein above.

At block 1495, the computer system utilizes the identified best path for processing new (previously unseen) sequences of user interface commands in order to identify recurring patterns of user interface commands corresponding to form instances. The identified form instances may be utilized, e.g., for training a model which is then used for user interface automation.

FIG. 15 depicts an example computer system 1500 which may perform the methods described herein. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 1500 includes a processing device 1502, a main memory 1504 (e.g., read-only memory (ROM), flash memory, dynamic random access memory (DRAM) such as synchronous DRAM (SDRAM)), a static memory 1506 (e.g., flash memory, static random access memory (SRAM)), and a data storage device 1516, which communicate with each other via a bus 1508.

Processing device 1502 represents one or more general-purpose processing devices such as a microprocessor, central processing unit, or the like. More particularly, the processing device 1502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1502 may also be one or more special-purpose processing devices such as an application specific integrated circuit (ASIC), a field programmable gate array (FPGA), a digital signal processor (DSP), network processor, or the like. The processing device 1502 is configured to execute instructions 1526 for implementing the user interface action encoder 104 of FIG. 1 and to perform the operations and steps discussed herein (e.g., method 1300 of identifying repeating sequences of user interface commands for completing a certain task and/or method 1400 of identifying repeating sequences of user interface commands for completing a certain user interface form).

The computer system 1500 may further include a network interface device 1522. The computer system 1500 also may include a video display unit 1515 (e.g., a liquid crystal display (LCD) or a cathode ray tube (CRT)), an alphanumeric input device 1512 (e.g., a keyboard), a cursor control device 1514 (e.g., a mouse), and a signal generation device 1520 (e.g., a speaker). In one illustrative example, the video display unit 1515, the alphanumeric input device 1512, and the cursor control device 1514 may be combined into a single component or device (e.g., an LCD touch screen).

The data storage device 1516 may include a computer-readable medium 1524 on which is stored the instructions 1526 embodying any one or more of the methods or functions described herein. The instructions 1526 may also reside, completely or at least partially, within the main memory 1504 and/or within the processing device 1502 during execution thereof by the computer system 1500, the main memory 1504 and the processing device 1502 also constituting computer-readable media. In some implementations, the instructions 1526 may further be transmitted or received over a network via the network interface device 1522.

While the computer-readable storage medium 1524 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methods of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method, comprising:
receiving, by a processing device, a sequence of user interface commands;
identifying a plurality of split points of the sequence of user interface commands;
generating a linear partition graph comprising a plurality of vertices corresponding to a subset of split points;
identifying a subset of paths in the linear partition graph; and
utilizing the subset of paths for identifying a recurring pattern in a new sequence of user interface commands.

2. The method of claim 1, wherein the recurring pattern corresponds to a task instance.

3. The method of claim 1, wherein the recurring pattern corresponds to a user interface form instance.

4. The method of claim 1, further comprising:
utilizing the recurring pattern for training a model facilitating user interface automation.

5. The method of claim 1, wherein each path in the linear partition graph defines a corresponding partitioning of the sequence of user interface commands into two or more sub-sequences.

6. The method of claim 1, wherein the subset of split points is selected based on corresponding quality metric values associated with each split point of the plurality of split points.

7. The method of claim 1, further comprising:
identifies a set of rules corresponding to the subset of paths, wherein each rule of the set of rules reproduces a corresponding partitioning of the sequence of user interface commands into two or more sub-sequences.

8. The method of claim 1, further comprising:
selecting a best path based on additional evaluation of the subset of paths.

9. A system comprising:
a memory; and
a processing device operatively coupled to the memory, the processing device configured to:
receive a sequence of user interface commands;
identify a plurality of split points of the sequence of user interface commands;
generate a linear partition graph comprising a plurality of vertices corresponding to a subset of split points;
identify a subset of paths in the linear partition graph; and
utilize the subset of paths for identifying a recurring pattern in a new sequence of user interface commands.

10. The system of claim 9, wherein the recurring pattern corresponds to a task instance.

11. The system of claim 9, wherein the recurring pattern corresponds to a user interface form instance.

12. The system of claim 9, wherein the processing device is further configured to:
utilizing the recurring pattern for training a model facilitating user interface automation.

13. The system of claim 9, wherein each path in the linear partition graph defines a corresponding partitioning of the sequence of user interface commands into two or more sub-sequences.

14. The system of claim 9, wherein the subset of split points is selected based on corresponding quality metric values associated with each split point of the plurality of split points.

15. The system of claim 9, wherein the processing device is further configured to:
identifies a set of rules corresponding to the subset of paths, wherein each rule of the set of rules reproduces a corresponding partitioning of the sequence of user interface commands into two or more sub-sequences.

16. A non-transitory computer-readable storage medium comprising executable instructions that, when executed by a computing system, cause the computing system to:
receive a sequence of user interface commands;
identify a plurality of split points of the sequence of user interface commands;
generate a linear partition graph comprising a plurality of vertices corresponding to a subset of split points;
identify a subset of paths in the linear partition graph; and
utilize the subset of paths for identifying a recurring pattern in a new sequence of user interface commands.

17. The non-transitory computer-readable storage medium of claim 16, wherein the recurring pattern corresponds to a task instance.

18. The non-transitory computer-readable storage medium of claim 16, wherein the recurring pattern corresponds to a user interface form instance.

19. The non-transitory computer-readable storage medium of claim 16, further comprising executable instructions that, when executed by the computing system, cause the computing system to:
utilizing the recurring pattern for training a model facilitating user interface automation.

20. The non-transitory computer-readable storage medium of claim 16, wherein each path in the linear partition graph defines a corresponding partitioning of the sequence of user interface commands into two or more sub-sequences.
